(19) United States
(12) Patent Application Publication
(10) Pub. No.: US 2021/0122023 A1
(43) Pub. Date: Apr. 29, 2021

(54) GARDENING TOOL WITH IDENTIFICATION FUNCTION

(71) Applicant: JYEN HERR ENTERPRISE CO., LTD., Changhua City (TW)

(72) Inventors: KEVIN YAO, Changhua City (TW); KUN-FU LIAO, Changhua City (TW); YI-CHANG WANG, Changhua City (TW); CHIEN-WEI LAI, Changhua City (TW)

(73) Assignee: JYEN HERR ENTERPRISE CO., LTD., Changhua City (TW)

(21) Appl. No.: 17/082,553

(22) Filed: Oct. 28, 2020

(30) Foreign Application Priority Data
Oct. 29, 2019 (TW) 108138945

(51) Int. Cl. B25F 3/00; H01R 13/631; H01R 13/639; H02K 5/22; B25F 5/02

(52) U.S. Cl. CPC B25F 3/00; H01R 13/631; H02K 11/33; H02K 5/225; B25F 5/02; H01R 13/639

(57) ABSTRACT

A gardening tool with identification function including an operating unit and a working unit is provided. The operating unit includes a first main body, a first electrical connector, and an operating device. The first electrical connector is set at one end of the first main body. The operating device includes a processor electrically connected to the first electrical connector. The processor stores operating parameters. The working unit includes a second main body, a second electrical connector, a motor, and a work piece. The electrical property of the second electrical connector is corresponding to one operating parameter in the processor. When the second main body is connected to the first main body, the second electrical connector is electrically connected to the first electrical connector. The processor selects one operating parameter according to the electrical property of the second electrical connector to control the output rotational speed or power of the motor.

### BACKGROUND OF THE INVENTION

### 1. Technical Field

The present invention relates generally to a gardening tool, and more particularly to a gardening tool applying to different work pieces.

### 2. Description of Related Art

Conventional gardening tools include grass mowers, chainsaws, hedge trimmers, leaf blowers, shoot remover, and fruit pickers, etc. Take a grass mower for example, it has a long body, one end of the body is provided with a cutter and a motor, and the other end is provided with an operating device. By manipulating the operating device, users can control the motor to drive the cutter to rotate, so as to perform mowing or other gardening maintenance operation.

The motor output rotational speed or power of an electric gardening tool is very important for the use effect. Different working environments and working goals need different motors to output appropriate rotational speed or power. For example, chainsaws are usually used for trees that are much harder than weeds, so the required motor output rotational speed or power has to be higher than the motor rotational speed or power required by grass mowers in order to achieve better work efficiency. Therefore, how to provide different motor rotational speeds or powers for different work pieces is one of the inventor's main research directions.

### BRIEF SUMMARY OF THE INVENTION

In view of the above, the primary objective of the present invention is to provide a gardening tool with identification function. After identifying the type of the work piece, the gardening tool controls the motor to output the rotational speed or power that is corresponding to the work piece.

The present invention provides a gardening tool with identification function including an operating unit and a working unit.

The operating unit includes a first main body, a first electrical connector, and an operating device, wherein the first electrical connector is set at one end of the first main body. The operating device includes a processor which is electrically connected to the first electrical connector, wherein the processor stores a plurality of operating parameters. The working unit includes a second main body, a second electrical connector, a motor, and a work piece, wherein the second main body is detachably connected to the first main body. The second electrical connector is set at one end of the second main body, and the motor and the work piece are set at another end of the second main body. The motor drives the work piece to function, wherein an electrical property of the second electrical connector is corresponding to one of the operating parameters stored in the processor.

Thereby, when the second main body is correspondingly connected to the first main body, the second electrical connector is electrically connected to the first electrical connector; according to the electrical property of the second electrical connector, the processor automatically selects one of the operating parameters to control motor rotational speed or motor power.

The effect of the present invention is that, when the user connects the second main body with different work pieces and the first main body, the processor is able to control the motor to output appropriate rotational speed or power for the work piece according to the electrical property of the second electrical connector.

### BRIEF DESCRIPTION OF THE SEVERAL VIEWS OF THE DRAWINGS

The present invention will be best understood by referring to the following detailed description of some illustrative embodiments in conjunction with the accompanying drawings, in which

FIG. 1 is a perspective view of the gardening tool with identification function of the first embodiment of the present invention;

FIG. 2 is a partial enlarged view of the gardening tool with identification function in FIG. 1;

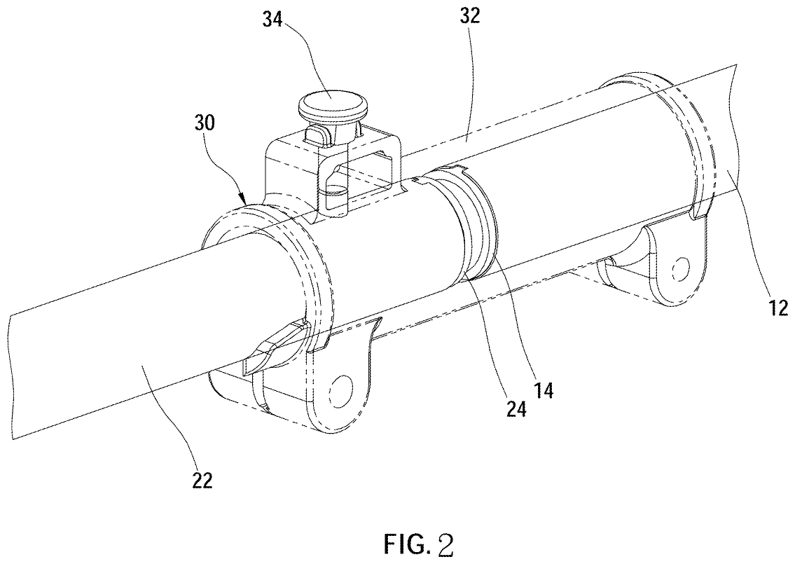

FIG. 3 is a partial exploded view of the gardening tool with identification function in FIG. 1;

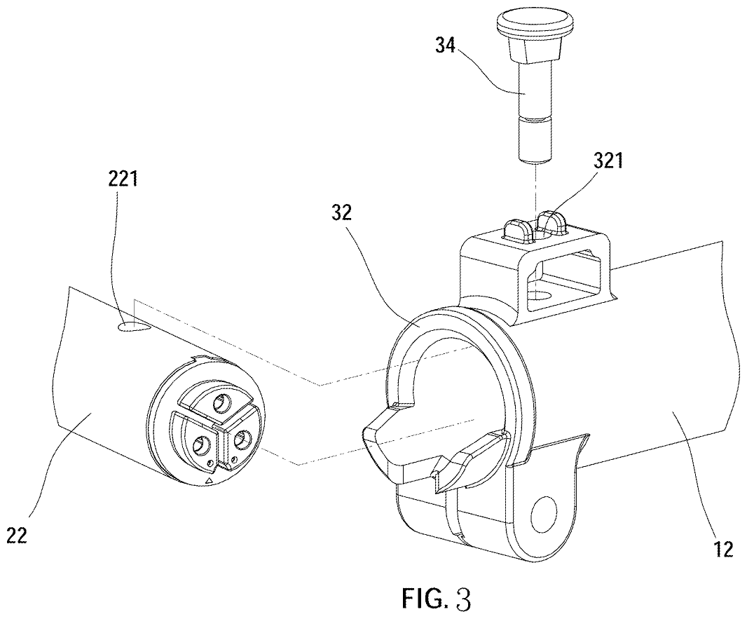

FIG. 4 is a partial exploded view of the gardening tool with identification function in FIG. 1;

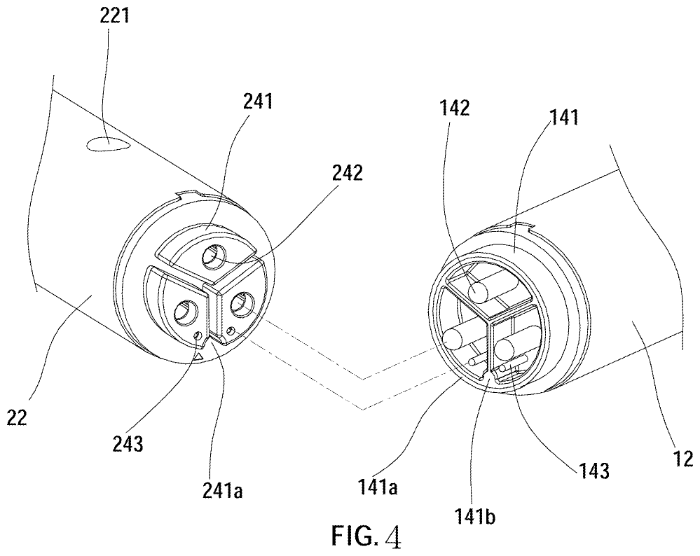

FIG. 5 is a partial exploded view of the gardening tool with identification function in FIG. 1; and

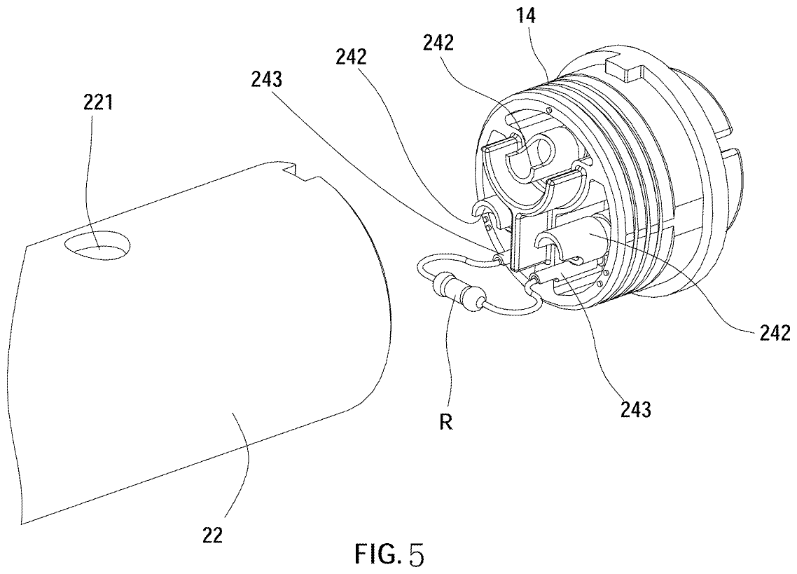

FIG. 6 is a schematic diagram of the gardening tool with identification function in FIG. 1 which applies to a different work piece.

### DETAILED DESCRIPTION OF THE INVENTION

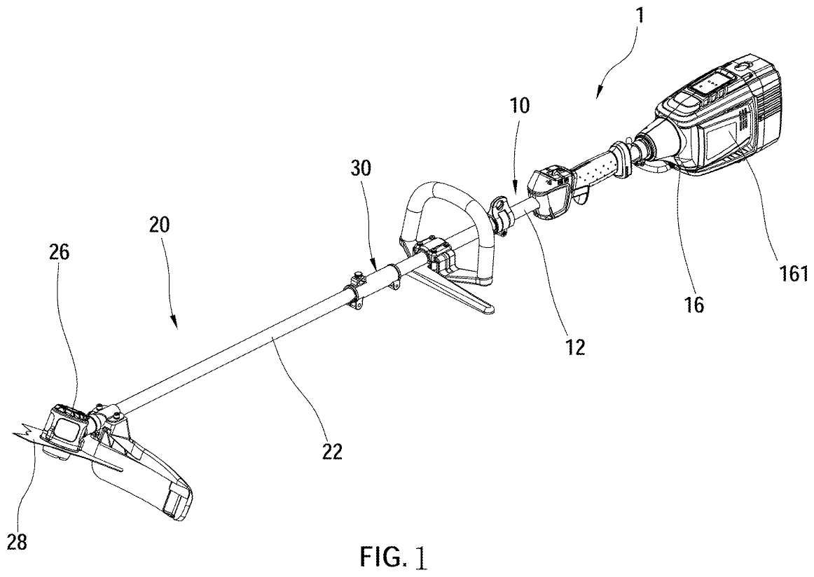

As shown in FIG. 1 to FIG, 5, a first embodiment of the present invention, a gardening tool with identification function 1 including an operating unit 10 and a working unit 20, is provided.

The operating unit 10 includes a first main body 12, a first electrical connector 14, and an operating device 16, wherein the first electrical connector 14 is set at one end of the first main body 12, while the operating device 16 is set at the other end of the first main body 12. The operating device 16 includes a power module (not shown) and a processor 161; the power module is electrically connected to the first electrical connector 14 and the processor 161, wherein the processor 161 stores a plurality of operating parameters. In this embodiment, the operating parameters built in the processor 161 of the operating device 16 include starting torque, starting rotational speed slope, and output power.

The working unit 20 includes a second main body 22, a second electrical connector 24, a motor 26, and a work piece 28. The second main body 22 is detachably connected to the first main body 12; the second electrical connector 24 is set at one end of the second main body 22, while the motor 26 and the work piece 28 are set at the other end of the second main body 22. The power module provides electrical energy for the motor 26 to actuate, so that the motor 26 drives the work piece 28 to function, wherein the work piece 28 can be a head portion of a grass mower, a chainsaw, a hedge trimmer, a leaf blower, a shoot remover, a fruit picker, or any other gardening tool. The electrical property of the second electrical connector 24 is corresponding to one of the operating parameters stored in the processor 161, wherein the second electrical connector 24 includes a passive element, e.g., a resistance, an inductance, or capacitance. For an explanatory purpose, the passive element is a resistance R in this embodiment.

Thereby, when the second main body 22 is connected to the first main body 12 correspondingly, the second electrical connector 24 is electrically connected to the first electrical connector 14. The processor 161 selects one of the operating parameters according to the electrical property :of the second electrical connector 24 to control the output rotational speed of the motor 26. In other embodiment, the processor 161 can select one of the operating parameters according to the electrical property of the second electrical connector 24 to control the output power of the motor 26 as well.

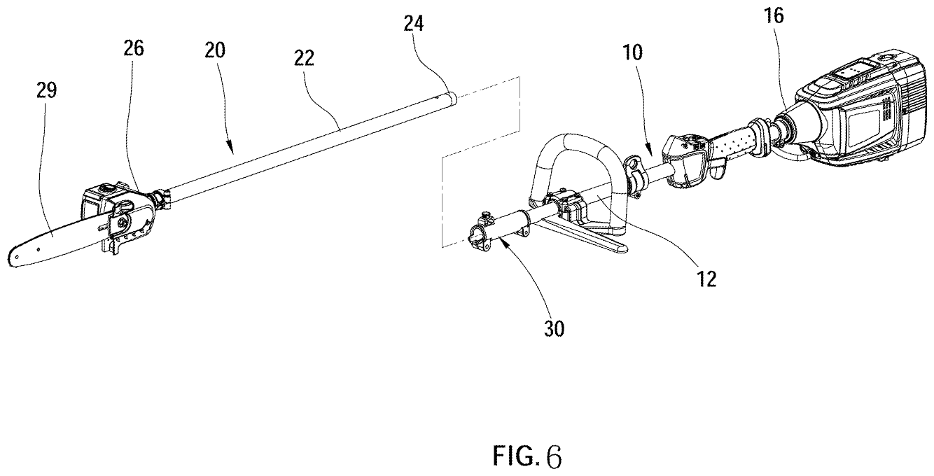

For example, the gardening tool includes a first working unit and a second working unit. The work piece of the first working unit is a chainsaw head 29 as shown in FIG. 6, wherein the second electrical connector includes a first resistance with 10k Ω, and the motor 26 is a first motor. The work piece 28 of the second working unit is a grass mower head as shown in FIG. 1, wherein the second electrical connector includes a second resistance with 100k Ω, and the motor 26 is a second motor. When the user selects the first working unit to be connected to the operating unit 10, the processor 161 determines that the work piece of the first working unit is the chainsaw head 29 according to the resistance value of the first resistance. Moreover, the processor 161 selects the parameters that match the chainsaw head among the operating parameters so as to control the first motor to reach the rotational speed of 10000 rpm within 0.5 seconds, maintains the rotational speed, and keeps the output power no more than 750W.

On the other hand, when the user selects the second working unit to be connected to the operating unit 10, the processor 161 determines that the work piece of the second working unit is the grass mower head according to the resistance value of the second resistance. Furthermore, the processor 161 selects the parameters that match the grass mower head among the operating parameters so as to control the second motor to reach the rotational speed of 5000 rpm within 2 seconds, maintains the rotational speed, and keeps the output power no more than 500W. That is, based on the difference in the resistance value of the second electrical connector 24, the operating unit 10 can identify the type of the work piece 28 of the working unit 20 connected to it. According to the type of the work piece, the operating unit 10 can effectively control the motor 26 to output rotational speed or power matching the work piece 28.

In this embodiment, the gardening tool with identification function 1 includes a connecting unit 30 for connecting the first main body 12 and the second main body 22, which makes the first main body 12 and the second main body 22 connected detachably. The connecting unit 30 includes a connecting pipe 32 and a fixing piece 34. The connecting pipe 32 has a first perforation 321, and the second main body 22 has a second perforation 221 near the second electrical connector 24. The fixing piece 34 passes through and is located in the first perforation 321 and the second perforation 221 so that the first main body 12 and the second main body 22 can be fixedly connected correspondingly.

In this embodiment, the first electrical connector 14 includes a first terminal seat 141 and a first terminal. The first terminal seat 141 has a circular sidewall 141a, and the first terminal is fixed on the first terminal seat 141. The first terminal includes a motor first terminal 142 and a resistance first terminal 143, which are electrically connected to the processor 161 respectively. The second electrical connector 24 includes a second terminal seat 241 and a second terminal, wherein the second terminal is fixed on the second terminal seat 241. The second terminal includes a motor second terminal 242 and a resistance second terminal 243. The resistance second terminal 243 is connected to the resistance R, and the motor second terminal 242 is electrically connected to the motor 26. When the first terminal seat 141 is connected and coupled with the second terminal seat 241, the circular sidewall 141a surrounds the outer edge of the second terminal seat 241. Additionally, the motor first terminal 142 and the motor second terminal 242 are in touch with and electrically connected to each other; the resistance first terminal 143 and the resistance second terminal 243 are in touch with and electrically connected to each other.

Preferably, the circular sidewall 141a is provided with a protruding member 141b on the inner periphery thereof, and the second terminal seat 241 is provided with a groove 241a at the position corresponding to the protruding member 141b. When the first terminal seat 141 is connected and coupled with the second terminal seat 241, the protruding member 141b and the groove 241a are connected. If users would like to connect the first terminal seat 141 and the second terminal seat 241, through the match of the protruding member 141b and the groove 241a, they can quickly position and connect the first terminal seat 141 and the second terminal seat 241 correctly, which brings the effect of fast positioning as well as avoids misalignment.

It must be noted that the embodiments described above are only preferred embodiments of the present invention. All equivalent structures which employ the concepts disclosed in this specification and the appended claims should fall within the scope of the present invention.

What is claimed is:

1. A gardening tool with identification function, comprising:
an operating unit comprising a first main body, a first electrical connector, and an operating device, wherein the first electrical connector is set at one end of the first main body; the operating device comprises a processor which is electrically connected to the first electrical connector, wherein the processor stores a plurality of operating parameters; and
working unit comprising a second main body, a second electrical connector, a motor, and a work piece, wherein the second strain body is detachably connected to the first main body; the second electrical connector is set at one end of the second main body, and the motor and the work piece are set at another end of the second main body; the motor drives the work piece to function, wherein an electrical property of the second electrical connector is corresponding to one of the operating parameters stored in the processor;
thereby, when the second main body is correspondingly connected to the first main body, the second electrical connector is electrically connected to the first electrical connector; according to the electrical property of the second electrical connector, the processor automatically selects one of the operating parameters to control motor rotational speed or motor power.

2. The gardening tool with identification function of claim 1, wherein the second electrical connector comprises a passive element.

3. The gardening tool with identification function of claim 2, wherein the passive element is a resistance.

4. The gardening tool with identification function of claim 2, wherein the first electrical connector comprises a first terminal seat and a first terminal; the first terminal is fixed on the first terminal seat; the second electrical connector comprises a second terminal seat and a second terminal, wherein the second terminal is fixed on the second terminal seat; whet the first terminal seat is connected and coupled with the second terminal seat, the first terminal and the second terminal are in touch with and electrically connected to each other.

5. The gardening tool with identification function of claim 4, wherein the first terminal seat has a circular sidewall; when the first ter urinal seat is connected and coupled with the second terminal seat, the circular sidewall surrounds an outer edge of the second terminal seat.

6. The gardening tool with identification function of claim 5, wherein the circular sidewall is provided with a protruding member on an inner periphery thereof; the second terminal seat is provided with a groove at a position corresponding to the protruding member; when the first terminal seat is connected and coupled with the second terminal seat, the protruding member and the groove are connected.

7. The gardening tool with identification function of claim 1, further comprising a connecting unit for connecting the first main body and the second main body, which makes the first main body and the second main body connected detachably.

8. The gardening tool with identification function of claim 2, further comprising a connecting unit for connecting the first main body and the second main body, which makes the first main body and the second main body connected detachably.

9. The gardening tool with identification function of claim 3, further comprising a connecting unit for connecting the first main body and the second main body, which makes the first main body and the second main body connected detachably.

10. The gardening tool with identification function of claim 4, further comprising a connecting unit for connecting the first main body and the second main body, which makes the first main body and the second main body connected detachably.

11. The gardening tool with identification function of claim 5, further comprising a connecting unit for connecting, the first main body and the second main body, which makes the first main body and the second main body connected detachably.

12. The gardening tool with identification function of claim 6, further comprising a connecting unit for connecting the first main body and the second main body, which makes the first main body and the second main body connected detachably.

13. The gardening tool with identification function of claim 7, wherein the connecting unit comprises a connecting pipe and a fixing piece; the connecting pipe has a first perforation, and the second main body has a second perforation near the second electrical connector; the fixing piece passes through and is located in the first perforation and the second perforation.

14. The gardening tool with identification function of claim 8, wherein the connecting unit comprises a connecting pipe and a fixing piece; the connecting pipe has a first perforation, and the second main body has a second perforation near the second electrical connector; the fixing piece passes through and is located in the first perforation and the second perforation.

15. The gardening tool with identification function of claim 9, wherein the connecting unit comprises a connecting pipe and a fixing piece; the connecting pipe has a first perforation, and the second main body has a second perforation near the second electrical connector; the fixing piece passes through and is located in the first perforation and the second perforation.

16. The gardening tool with identification function of claim 10, wherein the connecting unit comprises a connecting pipe and a fixing piece; the connecting pipe has a first perforation, and the second main body has a second perforation near the second electrical connector; the fixing piece passes through and is located in the first perforation and the second perforation.

17. The gardening tool with identification function of claim 11, wherein the connecting unit comprises a connecting pipe and a fixing piece; the connecting pipe has a first perforation, and the second main body has a second perforation near the second electrical connector; the fixing piece passes through and is located in the first perforation and the second perforation.

18. The gardening tool with identification function of claim 12, wherein the connecting unit comprises a connecting pipe and a fixing piece; the connecting pipe has a first perforation, and the second main body has a second perforation near the second electrical connector; the fixing piece passes through and is located in the first perforation and the second perforation.

19. The gardening tool with identification function of claim 1, wherein the operating parameters built in the processor of the operating device comprises starting torque, starting rotational speed slope, and output power.
